(19) United States
(12) Patent Application Publication
(10) Pub. No.: US 2025/0184443 A1
(43) Pub. Date: Jun. 5, 2025

(54) DISPLAY DEVICE INCLUDING BATTERY AND CONTROLLING METHOD THEREOF

(71) Applicant: Samsung Electronics Co., Ltd., Suwon-si (KR)

(72) Inventors: Moonyoung KIM, Suwon-si (KR); Kyungsoo Park, Suwon-si (KR); Keonwoo Kim, Suwon-si (KR)

(73) Assignee: Samsung Electronics Co., Ltd., Suwon-si (KR)

(21) Appl. No.: 19/050,574

(22) Filed: Feb. 11, 2025

Related U.S. Application Data
(63) Continuation of application No. PCT/KR2023/011936, filed on Aug. 11, 2023.

(30) Foreign Application Priority Data
Sep. 30, 2022 (KR) 10-2022-0125689
Nov. 25, 2022 (KR) 10-2022-0160574

(51) Int. Cl. H04N 5/63; G09G 3/32; H02J 7/00; H02J 50/80; H04N 5/64

(52) U.S. Cl. CPC H04N 5/63; G09G 3/32; H02J 7/0063; H02J 50/80; H04N 5/64; G09G 2320/0626; G09G 2330/021; G09G 2370/16

(57) ABSTRACT

A display device includes: a display operable in a landscape mode and a portrait mode; a stand and including a power circuit configured to receive external power, a first battery, and a charging and discharging circuit configured to control charging and discharging of the first battery; and one or more processors configured to: control the charging and discharging circuit to charge the first battery using the external power, based on a user command for turning on the display being received, provide a portion of the external power to the display as first driving power, and control the charging and discharging circuit to provide another portion of the external power to the first battery as charging power, where the one or more processors are configured to provide output power of the first battery to the display as second driving power in a battery priority use mode.

### CROSS-REFERENCE TO RELATED APPLICATIONS

This application is a continuation of International Application No. PCT/KR2023/011936, filed on Aug. 11, 2023, in the Korean Intellectual Property Receiving Office, which is based on and claims priority to Korean Patent Application No. 10-2022-0125689, filed on Sep. 30, 2022 and Application No. 10-2022-0160574, filed on Nov. 25, 2022, in the Korean Intellectual Property Office, the disclosures of which are incorporated by reference herein in their entireties.

### BACKGROUND

### 1. Field

This disclosure relates to a display device and a controlling method thereof, and more particularly, to a display device including a battery and a removable smart shelf and a controlling method thereof.

### 2. Description of Related Art

With advancement of electronic technology, various electric devices are being developed. In particular, mobile display devices have been developed in recent years.

A display device is not fixed to locked to the location where it was initially installed, but may be moved as desired by a user.

In this case, in order to move the display device without spatial constraints such as having to be located adjacent to an outlet, a display device equipped with a battery, etc. is being developed and popularized.

There is a growing need for a device and method for efficiently providing external power to the internal load of a display device equipped with a battery or power due to battery discharge, and there is a growing demand for a device and method for mounting an external device connected to the display device even when the display device is moved and moving it together with the display device.

### SUMMARY

Aspects will be set forth in part in the description which follows and, in part, will be apparent from the description, or may be learned by practice of the presented embodiments.

According to an aspect of an embodiment, a display device may include: a display operable in a landscape mode and a portrait mode; a stand configured to support the display and including a power circuit configured to receive external power, a first battery, and a charging and discharging circuit configured to control charging and discharging of the first battery; and one or more processors configured to: control the charging and discharging circuit to charge the first battery using the external power, based on a user command for turning on the display being received, provide a portion of the external power to the display as first driving power, and control the charging and discharging circuit to provide another portion of the external power to the first battery as charging power, where the one or more processors are configured to provide output power of the first battery to the display as second driving power in a battery priority use mode by setting a second output voltage of the charging and discharging circuit to be greater than a first output voltage of the power circuit.

The one or more processors may be further configured to: adjust an output luminance of the display based on a size of the second driving power in the battery priority use mode, where the output luminance of the display according to the second driving power is less than an output luminance of the display according to the first driving power.

The one or more processors may be further configured to: based on the external power not being received from the power circuit, automatically switch to the battery priority use mode, provide the second driving power to the display through a diode connected in parallel to the charging and discharging circuit for a threshold time after the automatic switch to the battery priority use mode, and provide the second driving power to the display through the charging and discharging circuit after the threshold time elapsed.

The one or more processors may be further configured to: based on the second driving power provided to the display through the diode for the threshold time being less than a minimum driving power of a plurality of LED elements included in the display, adjust an output luminance of the display to be less than a threshold luminance or turn off the plurality of LED elements for the threshold time.

The one or more processors may be further configured to: based on the automatic switch to the battery priority use mode, set the second output voltage of the charging and discharging circuit to be greater than the first output voltage of the power circuit, and based on the external power being received by the power circuit in the battery priority use mode, receive the external power from the power circuit and provide the first driving power to the display, and provide the charging power to the first battery.

The display device may further include a smart shelf removably attachable to the stand, where the one or more processors are further configured to: based on the smart shelf being attached to the stand, provide first partial power from the external power to the display as the first driving power, provide second partial power from the external power to the first battery as the charging power, and provide third partial power from the external power to the smart shelf, where the smart shelf includes: a communication interface configured to perform communication with an external device, and where the one or more processors are further configured to: provide the third partial power to the communication interface; and based on an image signal being received from the external device through the communication interface, transmit the image signal to the display.

The smart shelf may further include: a second battery, where the one or more processors are further configured to provide a portion of the third partial power to the communication interface, and provide another portion of the third partial power to the second battery as charging power.

The one or more processors may be further configured to: separate the second partial power and the third partial power from the external power such that the charging power of the first battery is greater than the charging power of the second battery, based on a feedback signal indicating that the first battery is charged being received from the charging and discharging circuit, re-separate the second partial power and the third partial power from the external power, and provide a portion of the re-separated third partial power to the communication interface, and provide another portion to the second battery as the charging power.

The smart shelf may further include: a wireless power transmission module, and where the one or more processors are further configured to: provide a portion of the third partial power to the communication interface, and based on the external device being located on the smart shelf, transmit another portion of the third partial power to the external device through the wireless power transmission module.

The one or more processors may be further configured to: based on the external power not being received from the power circuit, automatically switch to the battery priority use mode, and provide output power of the first battery to the display as the second driving power, and based on a feedback signal indicating that the first battery is discharged being received from the charging and discharging circuit, provide output power of the second battery to the display as third driving power.

The smart shelf may be horizontal to a floor on which the display device is located.

The stand may further include: a driver configured to move the smart shelf, where the one or more processors are further configured to: based on the display being in the landscape mode, control the driver to cause the smart shelf to be located at a first location corresponding to the landscape mode on the stand, and based on the display being in the portrait mode, control the driver to cause the smart shelf to be located at a second location corresponding to the portrait mode.

According to an aspect of an embodiment, a controlling method of a display device may include: controlling a charging and discharging circuit to charge a first battery using external power received through a power circuit; based on a user command for turning on a display being received, providing a portion of the external power to the display as first driving power; controlling the charging and discharging circuit to provide another portion of the external power to the first battery as charging power; and providing output power of the first battery to the display as second driving power in a battery priority use mode by setting a second output voltage of the charging and discharging circuit to be greater than a first output voltage of the power circuit.

The method may further include: adjusting an output luminance of the display based on a size of the second driving power in the battery priority use mode, where the output luminance of the display according to the second driving power is less than an output luminance of the display according to the first driving power.

The providing output power of the first battery to the display may include: based on the external power not being received from the power circuit, automatically switching to the battery priority use mode; providing the second driving power to the display through a diode connected in parallel to the charging and discharging circuit for a threshold time after the automatic switch to the battery priority use mode; and providing the second driving power to the display through the charging and discharging circuit after the threshold time elapsed.

According to an aspect of an embodiment, a computer-readable recording medium including a program that executes a controlling method of a display device according to an embodiment, the controlling method of the display device may include controlling a charging and discharging circuit to charge a first battery using external power received through a power circuit, based on a user command for turning on a display being received, providing a portion of the external power to the display as first driving power, controlling the charging and discharging circuit to provide another portion of the external power to the first battery as charging power, and providing output power of the first battery to the display as second driving power in a battery priority use mode by setting a second output voltage of the charging and discharging circuit to be greater than a first output voltage of the power circuit.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view provided to explain a display device including a display and a stand according to an embodiment;

FIG. 2 is a block diagram illustrating a configuration of a display device according to an embodiment;

FIG. 3 is a detailed block diagram illustrating a configuration of a display device according to an embodiment;

FIG. 4 is a view provided to explain a display device that provides charging power to a battery in an on state of a display according to an embodiment;

FIG. 5 is a view provided to explain a display device that provides charging power to a battery in an off state of a display according to an embodiment;

FIG. 6 is a view provided to explain a battery priority use mode according to an embodiment;

FIG. 7 is a view provided to explain an operation of a display device that does not receive external power according to an embodiment;

FIG. 8 is a view provided to explain a smart shelf attachable to a stand according to an embodiment;

FIG. 9 is a detailed block diagram illustrating a configuration of a display device with an attached smart shelf according to an embodiment;

FIG. 10 is a view provided to explain a display device that provides a portion of external power to a smart shelf according to an embodiment;

FIG. 11 is a view provided to explain a display device that provides charging power to a battery included in a smart shelf according to an embodiment;

FIG. 12 is a view provided to explain a display device that provides charging power to each of a battery included in a stand and a battery included in a smart shelf in an off state of a display according to an embodiment;

FIG. 13 is a view provided to explain an additional function of a smart shelf according to an embodiment;

FIG. 14 is a view provided to explain a method of attaching and detaching a stand and a smart shelf according to an embodiment;

FIG. 15 is a view provided to explain a position of a smart shelf in each of a landscape mode and a portrait mode according to an embodiment;

FIG. 16 is a view provided to explain a display device and a smart shelf according to an embodiment; and

FIG. 17 is a flowchart provided to explain a controlling method of a display device according to an embodiment.

### DETAILED DESCRIPTION

Hereinafter, example embodiments of the present disclosure will be described in detail with reference to the accompanying drawings.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, in a specific case, terms arbitrarily chosen by an applicant may exist, in which case, the meanings of such terms will be described in detail in the corresponding descriptions of the disclosure. Therefore, the terms used in the embodiments of the disclosure need to be defined on the basis of the meanings of the terms and the overall contents throughout the disclosure rather than simple names of the terms.

An expression, “at least one of A or B” should be understood as indicating any one of “A”, “B” and “both of A and B.”

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

Singular expressions include plural expressions unless the context clearly dictates otherwise. In this specification, terms such as “have”, “may have”, “include”, “may include”, “comprise”, “may comprise”, or the like, are intended to designate the presence of features, numbers, steps, operations, components, parts, or a combination thereof described in the specification, but are not intended to exclude in advance the possibility of the presence or addition of one or more of other features, numbers, steps, operations, components, parts, or a combination thereof.

In exemplary embodiments, a “module” or a “unit” may perform at least one function or operation, and be implemented as hardware or software or be implemented as a combination of hardware and software. In addition, a plurality of “modules” or a plurality of “units” may be integrated into at least one module and be implemented as at least one processor except for a ‘module’ or a ‘unit’ that needs to be implemented as specific hardware.

In this specification, the term ‘user’ may refer to a person using an electronic device or an apparatus using an electronic device (e.g., an artificial intelligence electronic device).

Hereinafter, an embodiment of the present disclosure will be described in greater detail with reference to the accompanying drawings.

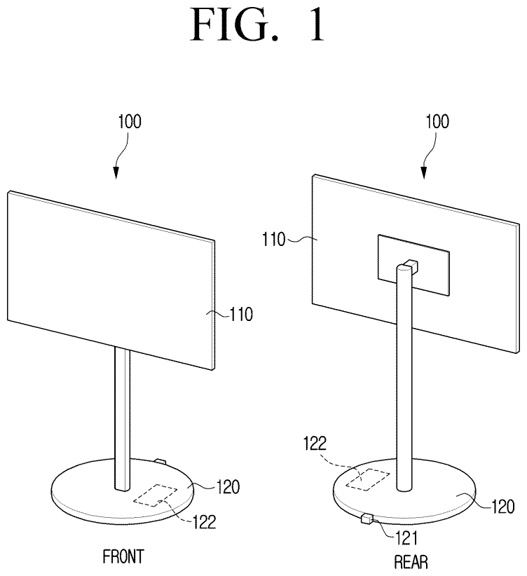

FIG. 1 is a view provided to explain a display device including a display and a stand according to an embodiment.

Referring to FIG. 1, a display device 100 according to an embodiment may provide an image. The display device 100 may be implemented as a TV, but is not limited thereto, and is applicable to any device having a display function, such as a video wall, a large format display (LFD), a digital signage, a digital information display (DID), a projector display, etc., without limitation. In addition, the display device 100 may be implemented as various types of displays, such as a liquid crystal display (LCD), an organic light-emitting diode (OLED), a liquid crystal on silicon (LCoS), a digital light processing (DLP), a quantum dot (QD) display panel, a quantum dot light-emitting diodes (QLED), etc.

The display device 100 according to an embodiment may include a display 110 and a stand 120 supporting the display 110.

In one example, the stand 120 includes a power circuit 121, and may receive external power via the power circuit 121. For example, the power circuit 121 may be wired to an outlet located on a wall, and may receive commercial power (hereinafter, referred to as external power).

According to an embodiment, the stand 120 may include a first battery 122. For example, the first battery 122 may be rechargeable by external power, and may output the charged power to provide power required to drive the display device 100 such as the display 110, i.e., driving power. Here, the first battery 122 may include a rechargeable secondary battery or a fuel cell may output charged power to provide power to drive the display device 100, such as the display 110, i.e., driving power. Here, the first battery 122 may include a rechargeable secondary cell or a fuel cell.

According to an embodiment, the display device 100 may be implemented as a mobile device without spatial constraints, such as having to be located adjacent to a wall outlet, since the display device 100 can be driven using the output power of the first battery 122 even if the power circuit 121 is not connected to a wall outlet by wire (i.e., even if external power is not received).

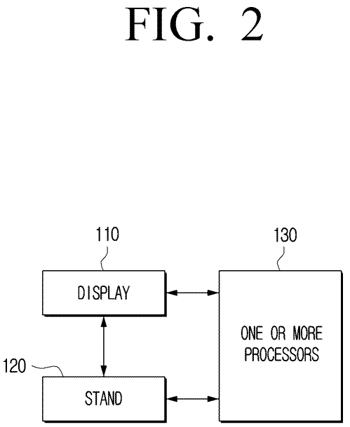

FIG. 2 is a block diagram illustrating configuration of a display device according to an embodiment.

Referring to FIG. 2, the display device 100 includes the display 110, a stand 120, and one or more processors 130.

First, the display 110 according to an embodiment may be implemented as various types of displays such as liquid crystal display (LCD), organic light-emitting diode (OLED), Liquid Crystal on Silicon (LCOS), Digital Light Processing (DLP), quantum dot (QD) display panel, quantum dot light-emitting diodes (QLED), Micro light-emitting diodes (μLED), Mini LED, etc.

The display device 100 may be implemented as a touch screen combined with a touch sensor, a flexible display, a rollable display, a 3D display, a display in which a plurality of display modules are physically connected, etc.

The stand 120 may fix the display 110. For example, as shown in FIG. 1, the stand 120 may be implemented as a stand-shaped support for the purpose of setting the display 110 on the floor (or ground, etc.). However, the stand 120 is not limited thereto, and the stand 120 may be implemented as a wall-mounted support for the purpose of fixing the display 110 to a wall, or may be implemented as an arm-shaped support for attaching (or fastening) to a table, etc. The shape of the stand 120 shown in FIG. 1 is an example, and the shape of the stand 120 may be implemented in various ways.

The stand 120 may also include a wheel at the bottom, and may further include a motor for driving the wheel, a brake for stopping the driving of the wheel, etc. The display device 100 may move by itself within the space using the wheel.

The stand 120 according to an embodiment may include the power circuit 121 for receiving external power. Here, the power circuit 121 is implemented as a switched mode power supply (SMPS), and may include a power factor correction circuit, i.e., a PFC circuit, to meet the driving power of the display device 100 and various regulations.

According to an embodiment, the power circuit 121 may convert external power, i.e., alternating current power, into direct current power to reliably supply the power to an internal load of the display device 100 (e.g., a board including the display 110, a first battery 122 included in the stand 120, the one or more processors 130, etc.).

The one or more processors 130 according to an embodiment may control the overall operations of the display device 100.

According to an embodiment, the processor 130 may be implemented as a digital signal processor (DSP) for processing digital signals, a microprocessor, or a time controller (TCON). However, the processor 130 is not limited thereto, and the processor 130 may include one or more of a central processing unit (CPU), a micro controller unit (MCU), a micro processing unit (MPU), a controller, an application processor (AP), a communication processor (CP), an ARM processor, and an Artificial Intelligence (AI) processor, or may be defined as the corresponding term. Further, the processor 130 may be implemented as a system on chip (SoC) with embedded processing algorithms, a large scale integration (LSI), or in the form of a field programmable gate array (FPGA). The processor 130 may perform various functions by executing computer executable instructions stored in the memory.

The one or more processors 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or any combination of the other components of the electronic apparatus, and may perform communication-related operations or data processing. The one or more processors 130 may execute one or more programs or instructions stored in the memory. For example, the one or more processors 130 may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor).

The one or more processors 130 may be implemented as a single core processor including a single core, or as one or more multicore processors including a plurality of cores (e.g., homogeneous multicore or heterogeneous multicore). When the one or more processors 130 are implemented as a multicore processor, each of the plurality of cores included in the multicore processor may include internal memory of the processor, such as cache memory and an on-chip memory, and a common cache shared by the plurality of cores may be included in the multicore processor. Each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the processor may mean a system-on-chip (SoC) in which at least one processor and other electronic components are integrated, a single-core processor, a multi-core processor, or a core included in a single-core processor or multi-core processor, and here, the core may be implemented as CPU, GPU, APU, MIC, DSP, NPU, hardware accelerator, or machine learning accelerator, etc., but the core is not limited to the embodiments of the present disclosure.

In particular, the one or more processors 130 according to an embodiment may drive the display device 100 using external power received by the power circuit 121. For example, the one or more processors 130 may drive the display 110 using external power, and may control a charging and discharging circuit 123 included in the stand 120 to charge the first battery 122 included in the stand 120.

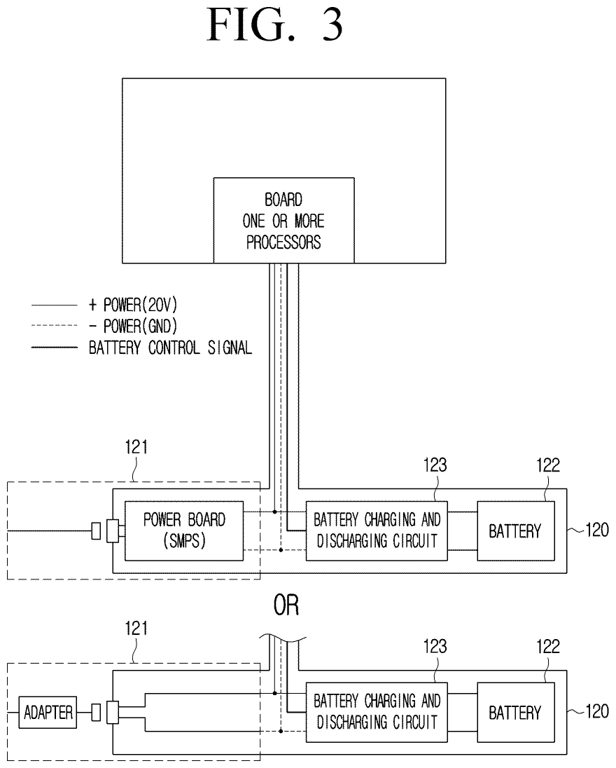

For example, the one or more processors 130 may provide a portion of the external power to the display 110 as first driving power to drive a plurality of LED elements included in the display 110, and the display 110 may light the plurality of LED elements using the first driving power. Further, the one or more processors 130 may provide the remainder of the external power received by the power circuit 121 to the first battery 122 as charging power, which will be described in greater detail with reference to FIG. 3.

FIG. 3 is a detailed block diagram illustrating configuration of a display device according to an embodiment.

Referring to FIG. 3, the stand 120 may include the power circuit 121 that receives external power, the first battery 122, and the charging and discharging circuit 123 that provides charging power to charge the first battery 122 or controls the first battery 122 to output (or discharge) charged power.

According to an embodiment, the power circuit 121 may provide power to each of the display 110, the charging and discharging circuit 123, and the one or more processors 130.

According to an embodiment, when a user command to turn the display 110 on is received, the one or more processors 130 may control the power circuit 121 to provide the display with a portion of the external power received by the power circuit 121 as first driving power.

Further, the one or more processors 130 may control the power circuit 121 and the charging and discharging circuit 123 to provide the remainder of the external power received by the power circuit 121 to the first battery 122 as charging power.

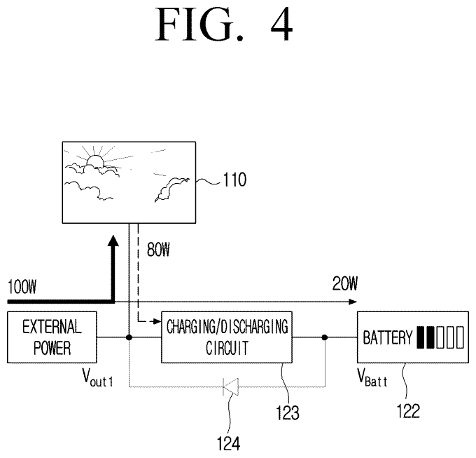

This will be explained in greater detail with reference to FIG. 4.

FIG. 4 is a view provided to explain a display device that provides charging power to a battery in an on state of a display according to an embodiment.

Referring to FIG. 4, the one or more processors 130 may provide a portion (e.g., 80 W) of the external power (e.g., 100 W) to the display 110 as first driving power, and the remainder (e.g., 20 W) of the external power may be provided to the first battery 122 via the charging and discharging circuit 123 as charging power.

Here, the specific numbers are only examples for convenience of explanation and are not limited thereto. For example, the one or more processors 130 may increase the ratio of the first driving power provided to the display 110 from the external power as the maximum output luminance of the display 110 increases (e.g., from 0.8 to 0.9, etc.)

Further, according to various embodiments, the feature of providing driving power to the display 110 includes the feature of providing power to various internal loads included in the display device 100 in addition to the display 110 for the overall operations of the display device 100, such as the display device 100 receiving an image signal and the display 110 outputting an image corresponding to the image signal.

The one or more processors 130 according to an embodiment may provide external power (e.g., 100 W) to the display 110 as first driving power, and may not provide charging power to the first battery 122. For example, when the image corresponding to the image signal is a high luminance image above a threshold output luminance, the one or more processors 130 may provide all of the external power to the display 110 as first driving power.

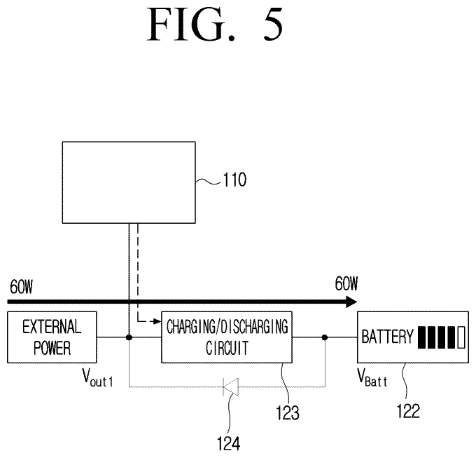

FIG. 5 is a view provided to explain a display device that provides charging power to a battery in an off state of a display according to an embodiment.

When a user command to turn off the display 110 is received, the one or more processors 130 according to an embodiment may control the charging and discharging circuit 123 to turn off the display 110 and provide external power (e.g., 60 W) to the first battery 122 as charging power.

For example, the one or more processors 130 may control the charging and discharging circuit 123 to provide charging power to the first battery 122 based on the maximum allowable power of the first battery 122 in the off state of the display 110.

According to an embodiment, the charging and discharging circuit 123 provides a constant current (CC) to the first battery 122 under control of the one or more processors 130, and when the internal voltage of the first battery 122 continuously rises and reaches a reference value, the charging and discharging circuit 123 may change the internal voltage of the first battery 122 to a constant voltage (CV) to prevent overvoltage, and continuously decrease the amount of current provided to the first battery 122 to complete charging of the first battery 122. However, the charging method for the first battery 122 of the charging and discharging circuit 123 is not limited to the CC/CV charging method described above, and it is of course possible to charge the first battery 122 using various charging methods.

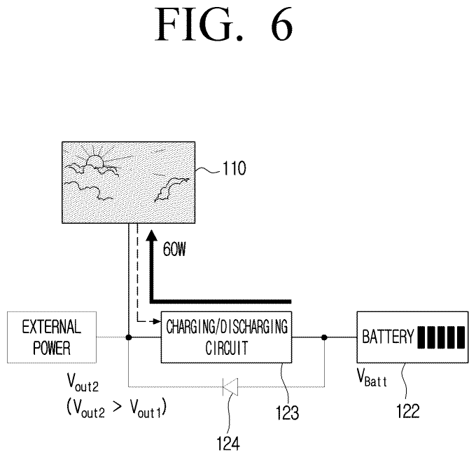

FIG. 6 is a view provided to explain a battery priority use mode according to an embodiment.

The one or more processors 130 according to an embodiment may operate the display device 100 in the battery priority use mode. Here, the battery priority use mode may be a mode in which the first battery 122 is discharged to provide driving power to the display 110, regardless of whether the power circuit 121 receives external power.

Referring to FIG. 6, the one or more processors 130 may, in the battery priority use mode, set a second output voltage Vout_2 corresponding to the charging and discharging circuit 123 greater than a first output voltage Vout_1 corresponding to the power circuit 121 (i.e., Vout_1<Vout_2) to provide the output power of the first battery 122 to the display 110 as second driving power, even when the power circuit 121 is connected to a wall outlet via wire to be able to receive external power.

In one example, the one or more processors 130 may control the charging and discharging circuit 123 so that the first battery 122 prevents overcurrent and outputs a constant current (CC), and when the first battery 122 outputs a certain amount of power (i.e., discharges) and the internal voltage of the first battery 122 drops below a threshold voltage, the discharging can be completed.

When the size of the second driving power provided to the display 110 through the first battery 122 is relatively small compared to the size of the first driving power provided to the display 110 through the power circuit 121, the one or more processors 130 may adjust the maximum output luminance of the display 110. For example, the one or more processors 130 may lower the maximum output luminance of the display 110 according to the size of the second driving power provided to the display 110 through the first battery 122.

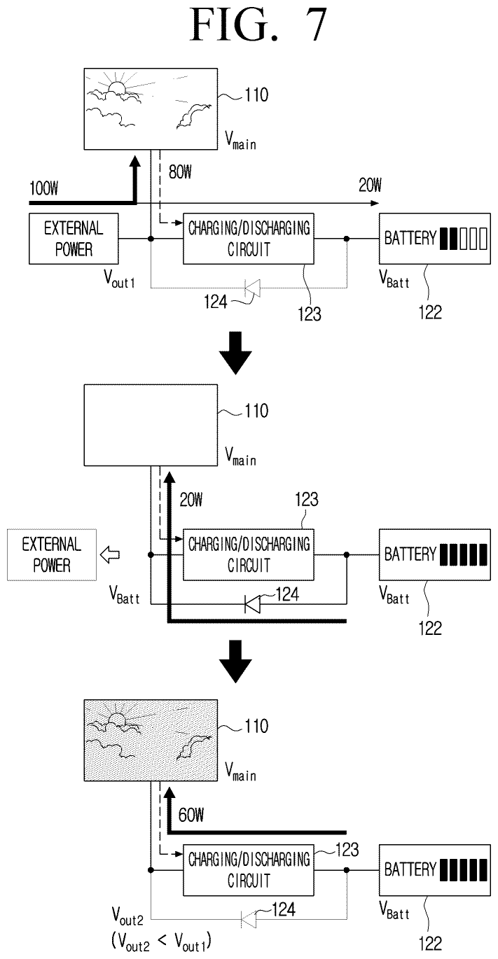

FIG. 7 is a view provided to explain an operation of a display device that does not receive external power according to an embodiment.

FIG. 7 is a view illustrating the operation of the display device 100, assuming that external power is received according to an embodiment, and the external power is not received while a portion of the external power is being provided to the display 110 as first driving power.

For example, when no external power is received while the one or more processors 130 provides a portion of the external power to the display 110 as first driving power and the remainder of the external power to the first battery 122 as charging power, the one or more processors 130 may automatically switch to the battery priority use mode. Subsequently, the one or more processors 130 may control the charging and discharging circuit 123 to discharge the first battery 122 to provide the power output by the first battery 122 to the display 110 as second driving power.

When the external power is not received suddenly, the direction of the current of the charging and discharging circuit 123 that is providing charging power to the first battery 122 cannot change instantaneously. In one example, the charging and discharging circuit 123 includes an inductor, and since the direction of the current flowing through the inductor (or the polarity of the inductor) cannot change instantaneously, the stand 120 may include a diode 124 connected in parallel to the charging and discharging circuit 123 to provide the power output by the first battery 122 to the display 110 as second driving power.

In one example, while the one or more processors are driving the display device 100 by providing a portion of the external power to the display 110 as first driving power, when the external power is suddenly not received (e.g., the power circuit 121 is disconnected from an outlet while connected to the outlet located on a wall via wire), the one or more processors 130 may provide a portion of the external power to the display 110 as first driving power to drive the display device 100, the one or more processors may automatically switch to the battery priority use mode and then, may provide the power output by the first battery 122 to the display 110 as second driving power for a threshold time.

Subsequently, the one or more processors 130 may provide the second driving power to the display 110 via the charging and discharging circuit 123 after the threshold time has elapsed.

Here, the size of the second driving power provided to the display 110 after the threshold time has elapsed may be relatively greater than the size of the second driving power provided to the display 110 during the threshold time.

When the power (e.g., 20 W) output by the first battery 122 for a threshold time, i.e., the second driving power, is less than the minimum driving power of the plurality of LED elements included in the display 110, the one or more processors 130 may adjust the output luminance of the display 110 to below the threshold luminance or turn off the plurality of LED elements for the threshold time

In one example, when the external power is suddenly not received, there is an effect that one or more processors 130 can continuously drive the display device 100 by adjusting the output luminance of the display 110 to below the threshold luminance for a threshold time, or even if the plurality of LED elements are turned off for the threshold time, by using the power output by the first battery 122 without re-booting the display device 100.

When no external power is received in the battery priority use mode, the one or more processors 130 may set a first output voltage (Vout_1) corresponding to the power circuit 121 to be greater than a second output voltage (Vout_2) corresponding to the charging and discharging circuit 123 (i.e., Vout_1>Vout_2) and thus, when the power circuit 121 receives the external power again (e.g., when the power circuit 121 is connected to an outlet via wire while not connected to the outlet located on the wall), the one or more processors 130 can automatically switch from the battery priority use mode to the normal mode to receive the external power from the power circuit 121 to provide the first driving power to the display 110 and the charging power to the first battery 122 via the charging and discharging circuit 123. Here, the normal mode may refer to a battery charging mode in which a portion of the external power is provided to the display 110 as the first driving power and the remainder is provided to the first battery 122 as charging power.

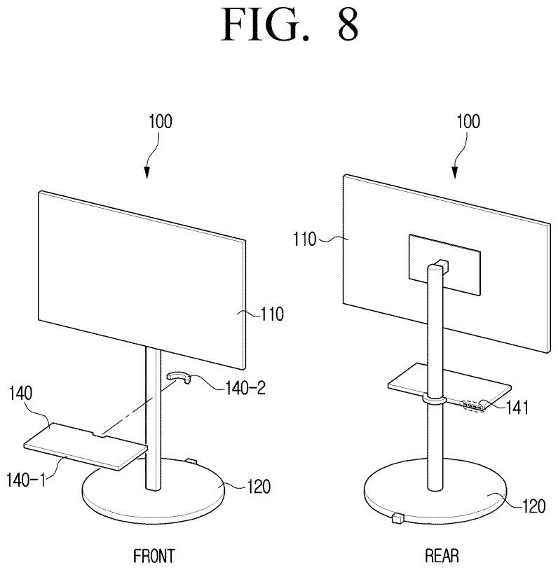

FIG. 8 is a view provided to explain a smart shelf attachable to a stand according to an embodiment.

The display device 100 according to an embodiment may further include a smart shelf 140. In one example, the smart shelf 140 is removably attachable to the stand 120, and may include a main body 140-1 and a fixture 140-2. The shape of each of the main body 140-1 and fixture 140-2 of the smart shelf 140 illustrated in FIG. 8 is only an example, and can of course be implemented in various forms.

Further, each of the main body 140-1 and the fixture 140-2 includes a magnetic material, and may be attachable to the stand 120 by combining the magnetic material included in the main body 140-1 and the magnetic material included in the fixture 140-2. However, this is only an example, and the smart shelf can be attached to and detached from the stand 120 in various ways. For example, each of the main body 140-1 and the fixture 140-2 includes a nut and a bolt, and can be attached to the stand 120 by fastening the bolt and the nut.

Here, the smart shelf 140 can be attached to the stand 120 horizontally to the floor on which the display device 100 is located. Although FIG. 8 illustrates the smart shelf 140 in a rectangular shape for convenience of explanation, the smart shelf 140 may be implemented in various shapes, including triangular, circular, and other shapes. In one example, the smart shelf 140 may include a flat surface on which items may be placed.

According to an embodiment, the smart shelf 140 includes the communication interface 141, and may perform communication with an external device through the communication interface 141. The communication interface 141 according to an embodiment receives various signals and data. For example, the communication interface 141 may perform communication with an external device through various wired/wireless communication methods such as such as an access point (AP)-based wireless fidelity (Wi-Fi, wireless local area network (LAN) network, a Bluetooth, a Zigbee, a wired/wireless local area network (LAN), a wide area network (WAN), Ethernet, an IEEE 1394, a high definition multimedia interface (HDMI), a Universal Serial Bus (USB), a mobile high-definition link (MHL), audio engineering society/European broadcasting union (AES/EBU), optical, coaxial, near field communication (NFC) communication, etc. In addition, the communication interface 141 may be implemented as a wired communication interface, for example, V-by-One, High Definition Multimedia Interface (HDMI) cable, Low Voltage Differential Signals (LVDS) cable, Digital Visual Interface (DVI) cable, D-subminiature (D-SUB) cable, Video Graphics Array (VGA) cable, optical cable, etc.

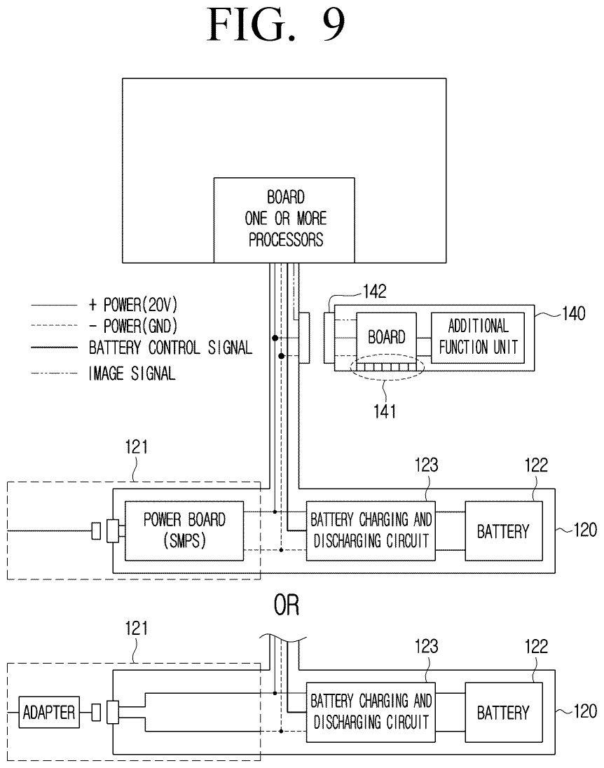

FIG. 9 is a detailed block diagram illustrating configuration of a display device with an attached smart shelf according to an embodiment.

In FIG. 9, descriptions overlapping with those of FIG. 3 will be omitted.

Referring to FIG. 9, the smart shelf 140 may include a communication interface 141 and a connection 142.

According to an embodiment, the connection 142 connects the internal load of the smart shelf 140 to the internal load of the display device 100, and may, for example, receive a control signal from the one or more processors 130 or receive power from the power circuit 121 or the first battery 122. In addition, the connection 142 may transmit an image signal received by the communication interface 141 from an external device to the one or more processors 130. The connection 142 may be implemented as a wired communication interface or a wireless communication interface according to various communication methods.

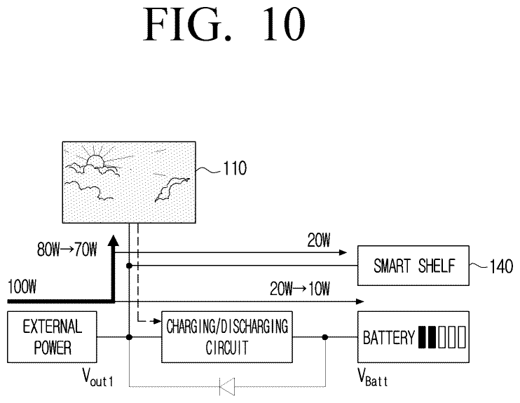

FIG. 10 is a view provided to explain a display device that provides a portion of external power to a smart shelf according to an embodiment.

When the smart shelf 140 is attached to the stand, the one or more processors 130 according to an embodiment may provide first partial power (e.g., 70 W) from the external power (e.g., 100 W) received by the power circuit (121) to the display 110 as first driving power, second partial power (e.g., 20 W) to the first battery 122 as charging power, and third partial power to the smart shelf 140. The internal load (e.g., the communication interface 141, the connection 142) of the smart shelf 140 may be driven using the third partial power.

Before the smart shelf 140 is attached, the one or more processors 130 transmit the external power to each of the display 110 and the first battery 122, and after the smart shelf 140 is attached, the one or more processors 130 transmit the external power to the display 110, the first battery 122, and the smart shelf 140, so that the size of the first driving power provided to the display 110 after the smart shelf 140 is attached may be smaller than the size of the first driving power provided to the display 110 before the smart shelf 140 is attached (e.g., 80 W->70 W). In addition, the size of the charging power provided to the first battery 122 after the smart shelf 140 is attached may be smaller than the size of the charging power provided to the first battery 122 before the smart shelf 140 is attached (e.g., 20 W->10 W).

However, this is only an example, and the present disclosure is not limited thereto. For example, the one or more processors 130 may maintain the size of the first driving power provided to the display 110 before the smart shelf 140 is attached and the size of the first driving power provided to the display 110 after the smart shelf 140 is attached (e.g., 80 W->80 W) in order to maintain the output luminance of the display 110, obtain the third partial power (e.g., 10 W) by lowering the size of the charging power provided to the first battery 122 after the smart shelf 140 is attached compared to before the smart shelf 140 is attached (e.g., 20 W->10 W), and provide the third partial power as the driving power of the smart shelf 140.

In another example, the one or more processors 130 may maintain the size of the first driving power provided to the display 110 before the smart shelf 140 is attached and the size of the first driving power provided to the display 110 after the smart shelf 140 is attached (e.g., 80 W->80 W), and when the smart shelf 140 is attached, may not charge the first battery 122 (i.e., reduce the size of the charging power provided to the first battery 122 to 0 W) (e.g., 20 W->0 W), obtain the third partial power (e.g., 20 W), and provide the third partial power as the driving power for the smart shelf 140.

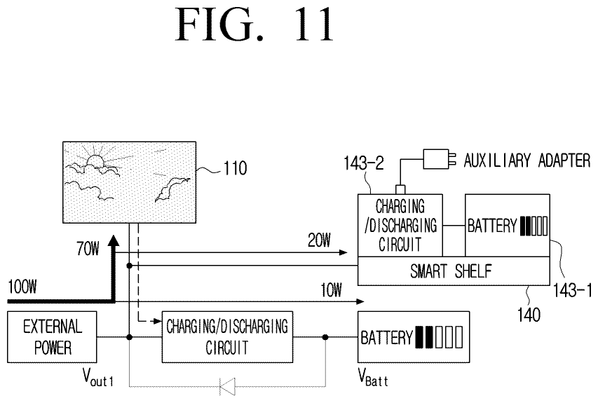

FIG. 11 is a view provided to explain a display device that provides charging power to a battery included in a smart shelf according to an embodiment.

The smart shelf 140 according to an embodiment may include a battery unit 143. Here, the battery unit 143 may include a second battery 143-1 and a charging and discharging circuit 143-2. The operation of each of the second battery 143-1 and the charging and discharging circuit 143-2 may be the same as the operation of each of the first battery 122 and the charging and discharging circuit 123 included in the stand 120.

The one or more processors 130 according to an embodiment may control the charging and discharging circuit 143-2 to provide the third partial power from the external power s to the smart shelf 140, provide a portion of the third partial power to an internal load included in the smart shelf 140, and provide the remainder of the third partial power to the second battery 143-1 as charging power.

The one or more processors 130 according to an embodiment may separate the second partial power and the third partial power from the external power such that the first battery 122 is charged before the second battery 143-1.

For example, the one or more processors 130 may provide the remaining power to the first battery 122 as charging power except for the first driving power to provide to the display 110 from the external power and the power to provide to the internal load included in the smart shelf 140.

Subsequently, when the one or more processors 130 receive a feedback signal indicating completion of charging the first battery 122 from the charging and discharging circuit 123, the one or more processors 130 may re-separate the second partial power and the third partial power from the external power to charge the second battery 143-1.

For example, the one or more processors 130 may provide the remaining power, excluding the first driving power to provide to the display 110 from the external power, to the smart shelf 140 as the third partial power, and the smart shelf 140 may control the charging and discharging circuit 143-2 to provide a portion of the third partial power to an internal load included in the smart shelf 140 and provide the remainder of the third partial power to the second battery 143-1 as charging power. In this case, the second partial power to provide to the first battery 122 may be 0 W.

The smart shelf 140 further includes a power circuit, and the power circuit included in the smart shelf 140 is connected to an outlet located on a wall via wire, and may also receive commercial power (hereinafter, referred to as external power).

In one example, when the power circuit included in the smart shelf 140 receives external power, the one or more processors 130 may control the charging and discharging circuit 143-2 to provide a portion of the external power received by the power circuit included in the smart shelf 140 to an internal load included in the smart shelf 140 and provide the remainder to the second battery 143-1 as charging power.

In one example, when no external power is received, the one or more processors 130 may automatically switch to a battery priority use mode and discharge in the order of the first battery 122 to the second battery 143-1. For example, the one or more processors 130 may provide the power output by the first battery 122 to the display 110 as the second driving power, and when the discharging of the first battery 122 is completed, may provide the power output by the second battery 143-1 to the display 110 as the third driving power. However, this is only an example, and the present disclosure is not limited thereto. For example, the one or more processors 130 may discharge in the order of the second battery 143-1 to the first battery 122.

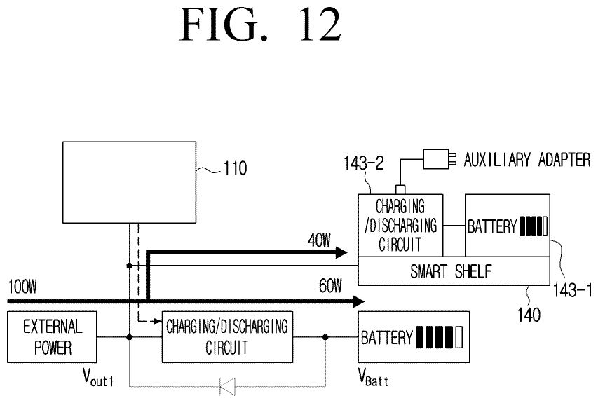

FIG. 12 is a view provided to explain a display device that provides charging power to each of a battery included in a stand and a battery included in a smart shelf in an off state of a display according to an embodiment.

When a user command to turn off the display 110 is received, the one or more processors 130 according to an embodiment may control the charging and discharging circuit 123 to turn off the display 110 and provide a portion of the external power (e.g., 100 W) (i.e., the second partial power) to the first battery 122 as charging power.

In addition, the one or more processors 130 may control the charging and discharging circuit 143-2 included in the smart shelf 140 to provide the remainder of the external power (i.e., the third partial power) to the second battery 143-1 as charging power.

For example, the one or more processors 130 may control the charging and discharging circuit 123 to provide the charging power to the first battery 122 based on the maximum allowable power of the first battery 122 in the off state of the display 110, and control the charging and discharging circuit 143-2 to provide the charging power to the second battery 143-1 based on the maximum allowable power of the second battery 143-1 in the off state of the display 110.

The one or more processors 130 according to an embodiment may charge the first battery 122 and the second battery 143-1 simultaneously, and may control the charging and discharging circuit 123 included in the stand 120 and the first battery 122 and the second battery 143-1 to charge one of the first battery 122 and the second battery 143-1 first, and the other of the first battery 122 and the second battery 143-1 later.

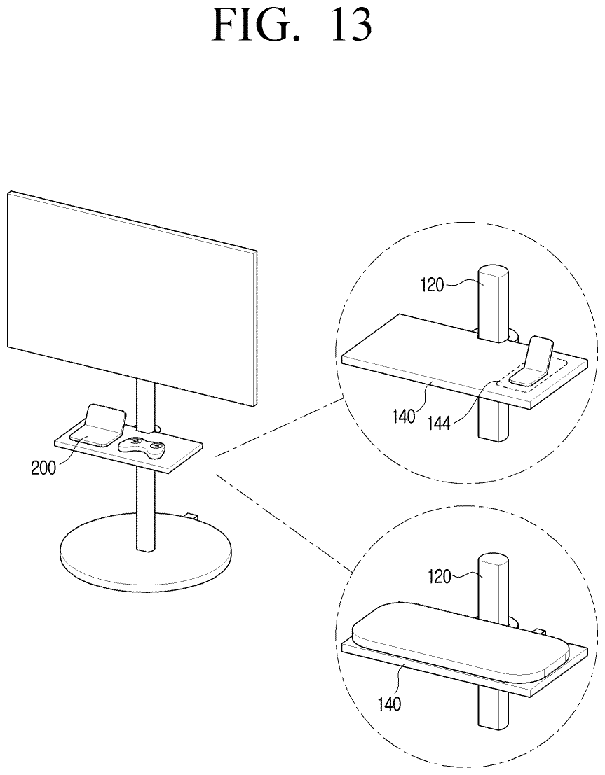

FIG. 13 is a view provided to explain an additional function of a smart shelf according to an embodiment.

Referring to FIG. 13, the smart shelf 140 according to an embodiment may perform communication with an external device 200 via the communication interface 141, and may transmit an image signal received from the external device 200 to the one or more processors 130 via the connection 142.

Here, the external device 200 may be implemented as an electronic device, such as a source device (e.g., a set-top box, a cloud server, an over-the-top media service (OTT service), etc.), a home automation control panel, a security control panel, a media box (e.g., Samsung HomeSync™, Apple TV™, or Google TV™), a game console (e.g., Xbox™, PlayStation™), an electronic dictionary, an electronic key, a camcorder, or an electronic picture frame. However, the present disclosure is not limited thereto, and the external device 200 may include at least one of a television, a user terminal device, a tablet PC, a mobile phone, a video phone, an e-book reader, a desktop PC, a laptop PC, a netbook computer, a workstation, a server, a PDA, a portable multimedia player (PMP), an MP3 player, a medical device, a camera, a virtual reality (VR) implementation device, or a wearable device. Here, the wearable device may include at least one of an accessory type of a device (e.g., a timepiece, a ring, a bracelet, an anklet, a necklace, glasses, a contact lens, or a head-mounted-device (HMD)), one-piece fabric or clothes type of a circuit (e.g., electronic clothes), a body-attached type of a circuit (e.g., a skin pad or a tattoo), or a bio-implantable type of a circuit. According to an embodiment, the smart shelf 140 is attached to the stand 120 horizontally to the floor where the display device 100 is located, and the external device 200 may be mounted on the plane of the smart shelf 140 (i.e., on top of the smart shelf 140). In this case, the smart shelf 140 is attached to the stand 120 so as to be able to withstand the load caused by the external device 200.

In addition, the smart shelf 140 may provide various additional functions.

In one example, the smart shelf 140 may include at least one wireless power transmission module.

According to an embodiment, when an electronic device including a wireless power receiving module is detected in a wireless charging area corresponding to a wireless power transmission module, one or more processors 130 may wirelessly transmit a portion of the third partial power of the external power (or in the battery priority use mode, a portion of the power output by the first battery 122 according to the discharge of the first battery 122 or a portion of the power output by the second battery 143-1 according to the discharge of the second battery 143-1) to the electronic device through the wireless power transmission module.

According to an embodiment, when an additional battery (or external battery, auxiliary battery, etc.) is connected to the smart shelf 140, the power circuit included in the smart shelf 140 may receive external power from the additional battery.

In one example, when the power circuit included in the smart shelf 140 receives external power from the additional battery, the one or more processors 130 may control the charging and discharging circuit 143-2 to provide a portion of the external power received by the power circuit included in the smart shelf 140 to an internal load included in the smart shelf 140 (e.g., the communication interface 141, the connection 142, the wireless power transfer module, etc.) and the remainder to the second battery 143-1 as charging power.

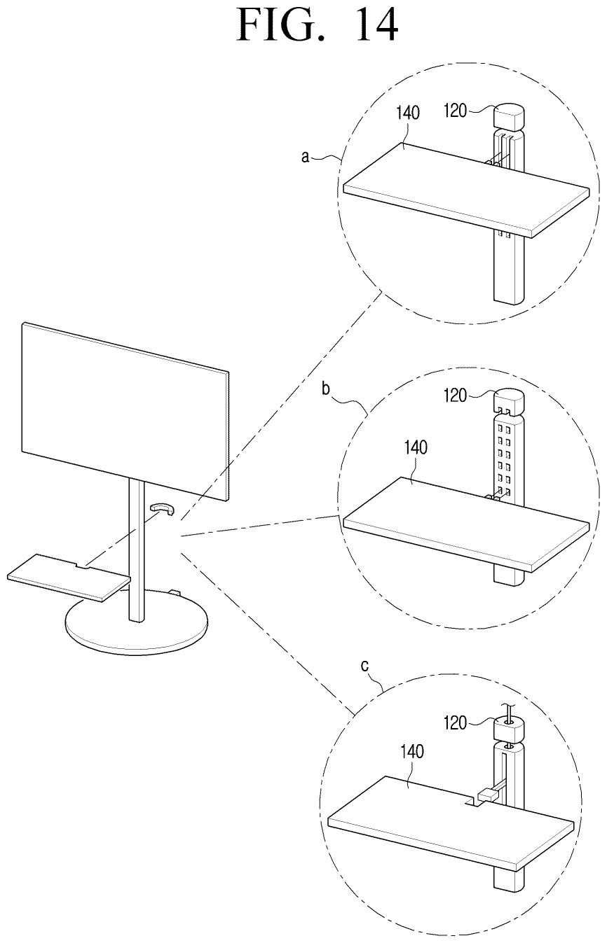

FIG. 14 is a view provided to explain a method of attaching and detaching a stand and a smart shelf according to an embodiment.

FIG. 14 is a view illustrating various implementations of the connection 142.

Referring to A in FIG. 14, the support of the stand 120 may include a first anode plate (e.g., + electrode plate) and a first cathode plate (e.g., − electrode plate) to provide power to the smart shelf 140.

The connection 142 according to an embodiment may include a second anode plate in contact with the first anode plate of the support, and a second cathode plate in contact with the first cathode plate of the support.

Each of the first anode plate and the first cathode plate of the support may be provided in the form of a rail to a certain length in the + and − directions of the z-axis, respectively, and when the connection 142 is connected to the support so that the second anode plate of the smart shelf 140 comes into contact with the first anode plate and the second cathode plate comes into contact with the first cathode plate, the smart shelf 140 may receive or transmit power through the stand 120.

The smart shelf 140 may be movable in the + direction or − direction of the z-axis while the electrode plates (first anode plate and first cathode plate) of the support and the electrode plates (second anode plate and second cathode plate) of the smart shelf 140 are in contact with each other.

For example, the user may directly move the smart shelf 140 in the + or − direction of the z-axis, or a wheel drive unit included in the display device 100 may move the smart shelf 140 in the + or − direction of the z-axis. Here, the wheel drive unit includes a rail provided on the support and a motor and a wheel provided on the smart shelf 140, and when the support and the smart shelf 140 are combined, the wheel is located on the rail, and the motor rotates the wheel to move the smart shelf 140 in the + or − direction of the z-axis.

The rail provided on the support may be electrode plates (first anode plate or first cathode plate) provided on the support, or may be further provided adjacent to the electrode plates on the support at the same length as the electrode plates.

Referring to B in FIG. 14, the support of the stand 120 may include a plurality of outlets provided with the first anode plate (e.g., + electrode plate) and the first cathode plate (e.g., − electrode plate).

The connection 142 according to an embodiment may include the second anode plate in contact with the first anode plate of the support and a plug including the second cathode plate in contact with the first cathode plate of the support. When the plug of the connection 142 is connected to one of the plurality of outlets on the support such that the second anode plate of the smart shelf 140 is in contact with the first anode plate and the second cathode plate is in contact with the first cathode plate, the smart shelf 140 may receive power or transmit power via the stand 120.

Referring to C in FIG. 14, the stand 120 includes a hole penetrating the inside of the support, and a line connected to the power circuit 121, the charging and discharging circuit 123, and the one or more processors 130, etc. may be provided within the hole.

The line is connectable with the connection 142 of the smart shelf 140, and when the line is connected to the connection 142, the smart shelf 140 may receive or transmit power over the line. Further, the smart shelf 140 may transmit an image signal received from the external device 200 to the one or more processors 130 over the line, or may receive a control signal transmitted by the one or more processors 130 over the line.

While the line provided on the support and the connection 142 of the smart shelf 140 are connected, the smart shelf 140 may be movable in the + or − direction of the z-axis.

For example, the user may directly move the smart shelf 140 in the + or − direction of the z-axis, or a wheel drive included in the display device 100 may move the smart shelf 140 in the + or − direction of the z-axis.

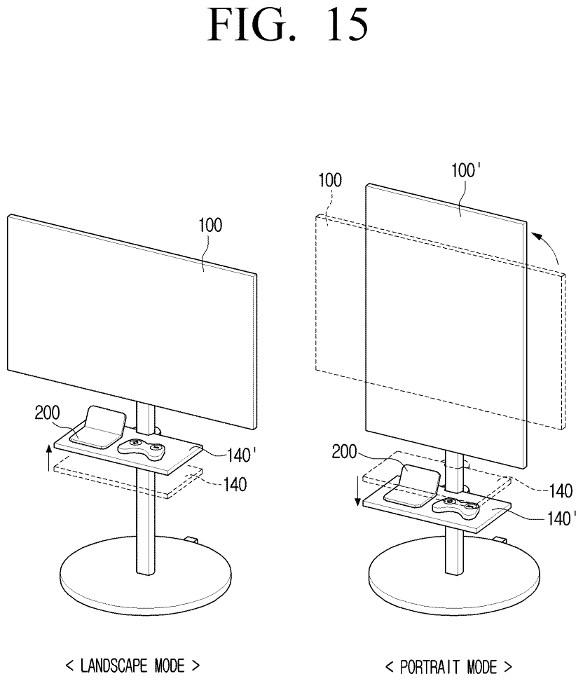

FIG. 15 is a view provided to explain a position of a smart shelf in each of a landscape mode and a portrait mode according to an embodiment.

Referring to FIG. 15, the display device 100 may operate in a display mode (or display mode, output mode, etc.) of either a landscape mode or a portrait mode.

Here, the landscape mode may be a display mode in which the horizontal ratio of the display provided in the display device 100 is longer than the vertical ratio, as shown on the left side of FIG. 15. The portrait mode may be a display mode in which the vertical ratio of the display provided in the display device 100 is longer than the horizontal ratio, as shown on the right side of FIG. 15.

The landscape mode may be referred to as horizontal mode, landscape direction mode, etc., but for the convenience of explanation, it will be referred to as landscape mode. The portrait mode may be referred to as vertical mode, portrait direction mode, etc., but for the convenience of explanation, it will be referred to as portrait mode.

When a user input to change the display mode is received, the one or more processors 130 according to an embodiment may control a rotation unit to rotate the display 110. In one example, the rotation unit may rotate the display 110. Specifically, the rotation unit may be connected to a gear (e.g., a circular gear) coupled to the display 110, and may rotate the display 110 by rotating the gear under control of the one or more processors 130. Alternatively, the rotation unit may stop rotating the gear under the control of the one or more processors 130, thereby stopping the rotation of the display 110.

To this end, the rotation unit may be implemented as a step motor capable of generating a rotational force, but this is only one embodiment, and the rotation unit may be implemented as various motors, such as an AC motor, a DC motor, etc.

When the display device 100 includes a rotation unit, the display 110 may be rotated according to the driving of the rotation unit. In other words, when a user input to change the display mode of the display 110 is received, the one or more processors 130 may control the rotation unit to rotate the display 110.

In this case, the display 110 may be rotated about a center of rotation while the front side maintains a constant direction. Here, the center of rotation may be located at a geometric center of the display 110, but is not necessarily limited thereto, and may be located elsewhere on the display 110.

According to an embodiment, the user may also rotate the display 110 directly.

For example, the user may freely rotate the display 110 by hand from 0 degrees to 360 degrees (or clockwise or counterclockwise), and when the display 110 is rotated 0 degrees (not rotated) or 180 degrees with reference to the landscape mode in which the width ratio is longer than the height ratio, it may operate in the landscape mode, and when the display 110 is rotated 90 degrees or 270 degrees, it may operate in the portrait mode.

According to an embodiment, the display device 100 may generate a coupling sound (e.g., a click sound) when the rotation angle of the display 110 reaches 0 degrees, 90 degrees, 180 degrees, 270 degrees, or 360 degrees with reference to the ground on which the display device 100 is located during the rotation of the display 110.

According to an embodiment, based on a predetermined distance between the display 110 and the smart shelf 140, the one or more processors 130 may control a wheel driver to move the smart shelf 140 in a + or − direction of the z-axis.

In one example, when the display device 100 changes from the landscape mode to the portrait mode, the one or more processors 130 may control the wheel driver to move the smart shelf 140 in the − direction of the z-axis.

In another example, when the display device 100 changes from the portrait mode to the landscape mode, the one or more processors 130 may control the wheel driving to move the smart shelf 140 in the + direction of the z-axis.

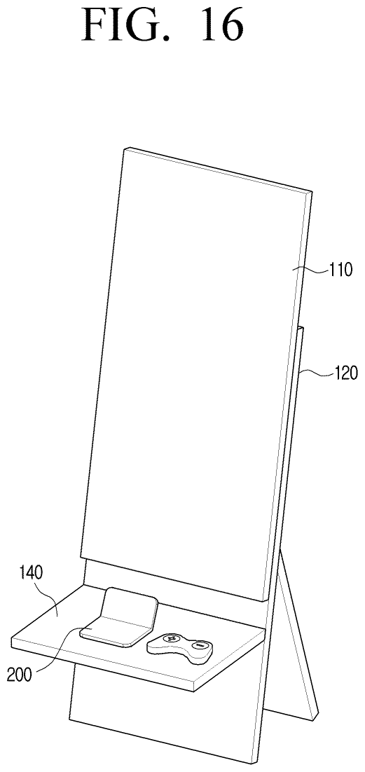

FIG. 16 is a view provided to explain a display device and a smart shelf according to an embodiment.

The stand 120 may be implemented in various shapes. Referring to FIG. 16, the width of the support included in the stand 120 may be similar to either the horizontal length or the vertical length of the display 110. Although the support may be implemented in various shapes, the smart shelf 140 may be removably attached to the support included in the stand 120.

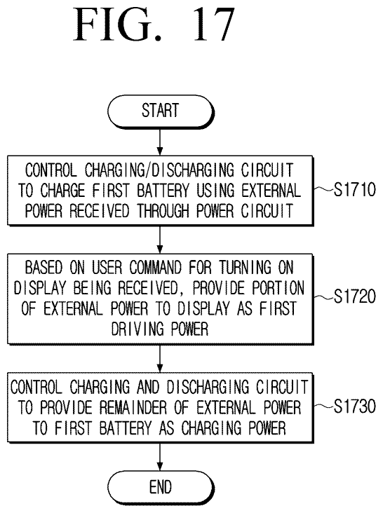

FIG. 17 is a flowchart provided to explain a controlling method of a display device according to an embodiment.

In the controlling method of the display device according to an embodiment, first, a charging and discharging circuit is controlled to charge a first battery using external power received via a power circuit (S1710).

Subsequently, when a user command to turn the display on is received, a portion of the external power is provided to the display as first driving power (S1720).

The charging and discharging circuit is then controlled to provide the remainder of the external power to the first battery as charging power (S1730).

The controlling method according to an embodiment may further include providing output power of the first battery to the display as second driving power by setting a second output voltage corresponding to the charging and discharging circuit to be greater than a first output voltage corresponding to the power circuit in a batter priority use mode.

The controlling method according to an embodiment may further include adjusting an output luminance of the display based on a size of the second driving power in the battery priority use mode, and the output luminance of the display according to the second driving power may be relatively lower than the output luminance of the display according to the first driving power.

In one example, the step of providing output power of the first battery to the display may include, when no external power is received from the power circuit, automatically switching to the battery priority use mode, providing the second driving power to the display via a diode connected in parallel to the charging and discharging circuit for a threshold time after the automatic switch to the battery priority use mode, and providing the second driving power to the display via the charging and discharging circuit after the threshold time has elapsed.

The controlling method according to an embodiment may further include, when the second driving power provided to the display via the diode for the threshold time is less than minimum driving power of a plurality of LED elements included in the display, adjusting the output luminance of the display to less than the threshold luminance or turning off the plurality of LED elements for the threshold time.

According to an embodiment, the step of providing output power of the first battery to the display may include, upon the automatic switch to the battery priority use mode, setting the second output voltage corresponding to the charging and discharging circuit to be greater than the first output voltage corresponding to the power circuit, and the controlling method may further include, when the external power is received again, providing the first driving power to the display and providing charging power to the first battery.

The controlling method according to an embodiment may further include, when a smart shelf removably attachable to a stand of the display device is attached to the stand, providing first partial power from external power to the display as first driving power, providing second partial power from the external power to the first battery as charging power, providing third partial power from the external power to the smart shelf, and, when an image signal is received from an external device via a communication interface included in the smart shelf, transmitting the image signal to the display.

Here, the controlling method according to an embodiment may further include providing a portion of the third partial power to the communication interface and providing the remainder of the third partial power to the second battery included in the smart shelf as charging power.

The controlling method according to an embodiment may further include separating the second partial power and the third partial power from the external power such that the first battery is charged before the second battery, and upon receiving a feedback signal from the charging and discharging circuit indicating completion of charging the first battery, re-separating the second partial power and the third partial power from the external power, providing a portion of the re-separated third partial power to the communication interface, and providing the remainder to the second battery as charging power.

However, that various embodiments of the present disclosure can be applied not only to a display device but also to various types of electronic devices.

The above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software. Each software may perform one or more functions and operations described in this disclosure.

Computer instructions for performing processing operations of the robot device according to the above-described various embodiments may be stored in a non-transitory computer-readable medium. When being executed by a processor of a specific device, the computer instructions stored in such a non-transitory computer-readable medium allows the specific device to perform processing operations in the electronic device according to the above-described various embodiments.

The non-transitory computer-readable medium refers to a medium that stores data semi-permanently and can be read by a device, rather than a medium that stores data for a short period of time, such as registers, caches, memory, etc. Specific examples of the non-transitory computer-readable medium may include CD, DVD, hard disk, Blu-ray disk, USB, memory card, ROM, etc.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A display device comprising:
a display operable in a landscape mode and in a portrait mode;
a stand configured to support the display, the stand comprising:
a power circuit configured to receive external power;
a first battery; and
a charging and discharging circuit configured to control charging and discharging of the first battery; and
one or more processors configured to:
control the charging and discharging circuit to charge the first battery using the external power,
based on a user command for turning on the display being received, provide a portion of the external power to the display as first driving power, and
control the charging and discharging circuit to provide another portion of the external power to the first battery as charging power,
wherein the one or more processors are further configured to provide output power of the first battery to the display as second driving power in a battery priority use mode by setting a second output voltage of the charging and discharging circuit to be greater than a first output voltage of the power circuit.

2. The display device as claimed in claim 1, wherein the one or more processors are further configured to:
adjust an output luminance of the display based on a size of the second driving power in the battery priority use mode, and
wherein the output luminance of the display according to the second driving power is less than an output luminance of the display according to the first driving power.

3. The display device as claimed in claim 1, wherein the one or more processors are further configured to:
based on the external power not being received from the power circuit, automatically switch to the battery priority use mode,
provide the second driving power to the display through a diode connected in parallel to the charging and discharging circuit for a threshold time after the automatic switch to the battery priority use mode, and
provide the second driving power to the display through the charging and discharging circuit after the threshold time elapsed.

4. The display device as claimed in claim 3, wherein the one or more processors are further configured to:
based on the second driving power provided to the display through the diode for the threshold time being less than a minimum driving power of a plurality of light-emitting diode (LED) elements included in the display, adjust an output luminance of the display to be less than a threshold luminance or turn off the plurality of LED elements for the threshold time.

5. The display device as claimed in claim 3, wherein the one or more processors are further configured to:
based on the automatic switch to the battery priority use mode, set the second output voltage of the charging and discharging circuit to be greater than the first output voltage of the power circuit, and
based on the external power being received by the power circuit in the battery priority use mode, receive the external power from the power circuit and provide the first driving power to the display, and provide the charging power to the first battery.

6. The display device as claimed in claim 1, further comprising a smart shelf removably attachable to the stand,
wherein the one or more processors are further configured to:
based on the smart shelf being attached to the stand, provide first partial power from the external power to the display as the first driving power, provide second partial power from the external power to the first battery as the charging power, and provide third partial power from the external power to the smart shelf,
wherein the smart shelf comprises:
a communication interface configured to perform communication with an external device, and
wherein the one or more processors are further configured to:
provide the third partial power to the communication interface, and
based on an image signal being received from the external device through the communication interface, transmit the image signal to the display.

7. The display device as claimed in claim 6, wherein the smart shelf further comprises:
a second battery, and
wherein the one or more processors are further configured to provide a portion of the third partial power to the communication interface, and provide a another portion of the third partial power to the second battery as charging power.

8. The display device as claimed in claim 7, wherein the one or more processors are further configured to:
separate the second partial power and the third partial power from the external power such that the charging power of the first battery is greater than the charging power of the second battery,
based on a feedback signal indicating that the first battery is charged being received from the charging and discharging circuit, re-separate the second partial power and the third partial power from the external power, and
provide a portion of the re-separated third partial power to the communication interface, and provide another portion to the second battery as the charging power.

9. The display device as claimed in claim 6, wherein the smart shelf further comprises:
a wireless power transmission module, and
wherein the one or more processors are further configured to:
provide a portion of the third partial power to the communication interface, and
based on the external device being located on the smart shelf, transmit another portion of the third partial power to the external device through the wireless power transmission module.

10. The display device as claimed in claim 7, wherein the one or more processors are further configured to:
based on the external power not being received from the power circuit, automatically switch to the battery priority use mode, and provide output power of the first battery to the display as the second driving power, and
based on a feedback signal indicating that the first battery is discharged being received from the charging and discharging circuit, provide output power of the second battery to the display as third driving power.

11. The display device as claimed in claim 6, wherein the smart shelf is horizontal to a floor on which the display device is located.

12. The display device as claimed in claim 6, wherein the stand further comprises:
a driver configured to move the smart shelf,
wherein the one or more processors are further configured to:
based on the display being in the landscape mode, control the driver to move the smart shelf to be to a first location corresponding to the landscape mode on the stand, and
based on the display being in the portrait mode, control the driver to move the smart shelf to a second location corresponding to the portrait mode.

13. A controlling method of a display device, the method comprising:
controlling a charging and discharging circuit to charge a first battery using external power received through a power circuit;
based on a user command for turning on a display being received, providing a portion of the external power to the display as first driving power;
controlling the charging and discharging circuit to provide another portion of the external power to the first battery as charging power; and
providing output power of the first battery to the display as second driving power in a battery priority use mode by setting a second output voltage of the charging and discharging circuit to be greater than a first output voltage of the power circuit.

14. The method as claimed in claim 13, further comprising:
adjusting an output luminance of the display based on a size of the second driving power in the battery priority use mode,
wherein the output luminance of the display according to the second driving power is less than an output luminance of the display according to the first driving power.

15. The method as claimed in claim 13, wherein the providing output power of the first battery to the display comprises:
based on the external power not being received from the power circuit, automatically switching to the battery priority use mode;
providing the second driving power to the display through a diode connected in parallel to the charging and discharging circuit for a threshold time after the automatic switch to the battery priority use mode; and
providing the second driving power to the display through the charging and discharging circuit after the threshold time elapsed.

16. The method as claimed in claim 13, further comprising:
based on the second driving power provided to the display through the diode for the threshold time being less than a minimum driving power of a plurality of light-emitting diode (LED) elements included in the display, adjusting an output luminance of the display to be less than a threshold luminance or turn off the plurality of LED elements for the threshold time.

17. The method as claimed in claim 15, wherein the providing output power of the first battery to the display comprises:
based on the automatic switch to the battery priority use mode, set the second output voltage of the charging and discharging circuit to be greater than the first output voltage of the power circuit, and
based on the external power being received by the power circuit in the battery priority use mode, receive the external power from the power circuit and provide the first driving power to the display, and provide the charging power to the first battery.

18. The method as claimed in claim 13, further comprising:
based on a smart shelf removably attachable to the stand being attached to the stand, providing first partial power from the external power to the display as the first driving power,
providing second partial power from the external power to the first battery as the charging power,
providing third partial power from the external power to the smart shelf, and
based on an image signal being received from the external device, transmitting the image signal to the display.

19. The method as claimed in claim 18, further comprising:
providing a portion of the third partial power to the communication interface, and provide a another portion of the third partial power to the second battery as charging power.

20. A non-transitory computer readable medium storing computer instructions which, when executed by at least one processor of a display device, cause the display device to perform operations comprising:
controlling a charging and discharging circuit to charge a first battery using external power received through a power circuit;
based on a user command for turning on a display being received, providing a portion of the external power to the display as first driving power;
controlling the charging and discharging circuit to provide another portion of the external power to the first battery as charging power; and
providing output power of the first battery to the display as second driving power in a battery priority use mode by setting a second output voltage of the charging and discharging circuit to be greater than a first output voltage of the power circuit.
